(19) United States
(12) Patent Application Publication
(10) Pub. No.: US 2021/0090060 A1
(43) Pub. Date: Mar. 25, 2021

(54) SETTLEMENT DEVICE AND METHOD

(71) Applicant: TOSHIBA TEC KABUSHIKI KAISHA, Tokyo (JP)

(72) Inventor: Yuichi Ogawa, Izunokuni Shizuoka (JP)

(21) Appl. No.: 16/903,420

(22) Filed: Jun. 17, 2020

(30) Foreign Application Priority Data
Sep. 19, 2019 (JP) 2019-170688

(51) Int. Cl. G06Q 20/20

(52) U.S. Cl. CPC G06Q 20/209; G06Q 20/204; G06Q 20/203; G06Q 20/202

(57) ABSTRACT

According to one embodiment, the settlement device of the embodiment includes merchandise information storage means for storing specific information for specifying one or a plurality of merchandises subjected to a sales registration process in a storage unit; extraction means for extracting all settlement means available for settlement of the merchandise specified by the specific information stored in the storage unit based on a table in which determination information for determining whether the plurality of kinds of settlement means are respectively available for the settlement for each kind of the specific information is stored; notification means for notifying extracted settlement means to be selectable; designation means for receiving information of one kind of the settlement means selected from the notified settlement means; and settlement processing means for performing a settlement process on the merchandise that can be settled with the settlement means of which the information is received.

### CROSS-REFERENCE TO RELATED APPLICATION

This application is based upon and claims the benefit of priority from Japanese Patent Application No. 2019-170688, filed in Sep. 19, 2019, the entire contents of which are incorporated herein by reference.

### FIELD

Exemplary embodiments described herein relate to a settlement device and a method.

### BACKGROUND

In the related art, in a store, there are a self-point of sales (POS) terminal in which a customer performs a sales registration operation and a settlement operation, a semi-self POS terminal in which a sales clerk performs a sales registration operation and a customer performs a settlement operation, and a general POS terminal in which a sales clerk performs a sales registration operation and a settlement operation.

In these POS terminals and settlement terminals, for example, when a settlement operation is performed by using a credit card, there are a kind of credit card that is available for settlement and a kind of credit card that is not available for settlement for each merchandise to be purchased.

However, in the related art, in some cases, a medium that is not available is designated, without knowing a medium that is available for settlement of a merchandise to be purchased.

### DESCRIPTION OF THE DRAWINGS

FIG. 1 is a schematic diagram illustrating a POS system according to an embodiment;

FIG. 2 is a schematic diagram illustrating a self-POS terminal;

FIG. 3 is a block diagram illustrating a hardware configuration of the self-POS terminal;

FIG. 4 is a memory map presenting a merchandise table;

FIG. 5 is a functional block diagram illustrating a functional configuration of the self-POS terminal;

FIG. 6 is a flowchart for describing a flow of a control process of the self-POS terminal;

FIG. 7 is a diagram illustrating a display screen of a display unit;

FIG. 8 is a diagram illustrating another display screen of the display unit;

FIG. 9 is a diagram illustrating still another display screen of the display unit; and

FIG. 10 is a diagram illustrating still another display screen of the display unit.

### DETAILED DESCRIPTION

An object of the exemplary embodiment is to provide a settlement device and a method capable of notifying a medium that is available for settlement of a merchandise to be purchased.

The settlement device of the embodiment includes merchandise information storage means for storing specific information for specifying one or a plurality of merchandises subjected to a sales registration process in a storage unit; extraction means for extracting all settlement means available for settlement of the merchandise specified by the specific information stored in the storage unit based on a table in which determination information for determining whether the plurality of kinds of settlement means are respectively available for the settlement for each kind of the specific information is stored; notification means for notifying extracted settlement means to be selectable; designation means for receiving information of one kind of the settlement means selected from the notified settlement means; and settlement processing means for performing a settlement process on the merchandise that can be settled with the settlement means of which the information is received.

Hereinafter, with respect to the drawings, embodiments are specifically described. In the embodiments, a self-POS terminal will be described as an example of a settlement device. The exemplary embodiment is not limited by the embodiments described below.

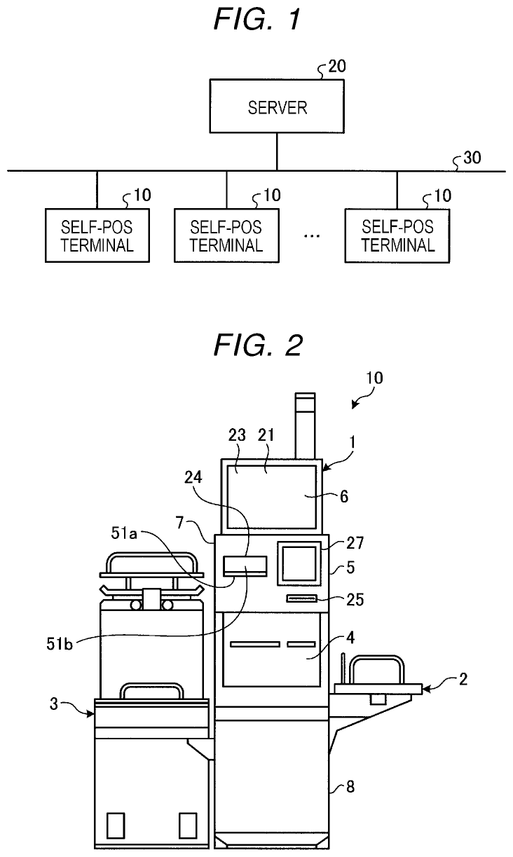

FIG. 1 is a schematic diagram illustrating a POS system according to an embodiment. The POS system is a system for selling a merchandise sold in a store and managing sales of the sold merchandise, and is mainly installed in a store. The POS system includes a plurality of self-POS terminals 10 installed in a store, and one server 20 which is installed in a back office of the store and is a higher-level device of the self-POS terminals 10. The self-POS terminals 10 and the server 20 are electrically connected to each other via a communication line 30 such as a local area network (LAN). Therefore, each of the self-POS terminals 10 and the server 20 can transmit and receive information to and from each other.

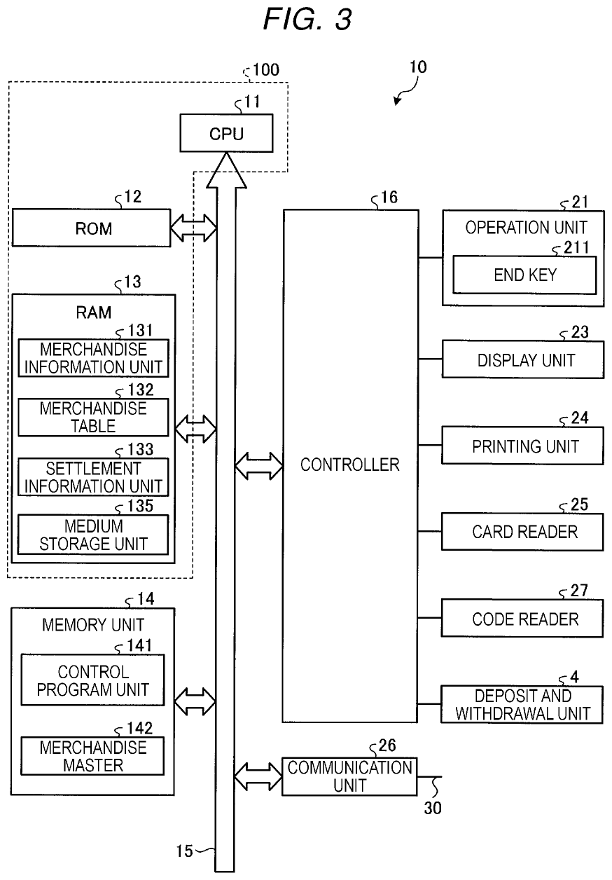

The self-POS terminal 10 enables a customer to perform a sales registration operation and a settlement operation of a merchandise to be purchased. With respect to the merchandise to be purchased, when the customer performs the sales registration operation of reading a symbol such as a barcode attached to the merchandise, the self-POS terminal 10 performs the sales registration process for the merchandise. The sales registration process refers to a process of causing the self-POS terminal 10 to display merchandise information (such as the name of a merchandise and a price) of the merchandise which is read based on a merchandise code acquired from the symbol and also to store the merchandise information in a merchandise information unit 131 (see FIG. 3). The self-POS terminal 10 may optically read an image of the symbol attached to the merchandise and acquire a corresponding merchandise code.

When the customer performs the settlement operation, the self-POS terminal 10 performs the settlement process. The settlement process refers to a process of displaying the total amount according to the transaction based on the merchandise information stored in a RAM or the like by the sales registration process and calculating and displaying a coin based on a deposit received from the customer. In case of the settlement with cash, the settlement process includes a process of instructing a coin machine to dispense a coin. In case of the settlement with a credit card, the settlement process includes a settlement process using the credit card. The settlement process includes a process of dispensing a slip or a receipt obtained by printing merchandise information or settlement information (such as a total amount, a deposit amount, and a coin amount) subjected to the sales registration process.

The self-POS terminal 10 transmits a merchandise code, merchandise information, settlement information, and the like of the merchandise subjected to the settlement process to the server 20 via the communication line 30. The self-POS terminal 10 transmits balance information obtained by balancing sales for a predetermined period of time (for example, one day) to the server 20 via the communication line 30.

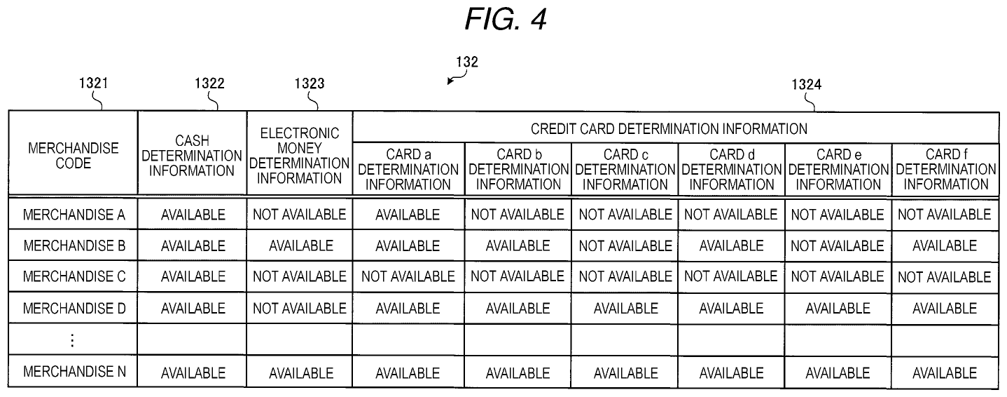

The server 20 intensively manages merchandise code, merchandise information, settlement information, balance information, and the like received from each of the self-POS terminals 10. That is, the server 20 manages sales or the like in one store. The server 20 transmits information relating to a merchandise master (see FIG. 3) to each of the self-POS terminals 10. The merchandise master 142 is associated with a merchandise code which is specific information for specifying a merchandise and stores merchandise information of the merchandise. The server 20 stores a merchandise table. The merchandise table is described below in FIGS. 3 to 4 but is periodically distributed from the server 20 to the self-POS terminals 10.

FIG. 2 is a front view illustrating an appearance of the self-POS terminal 10 according to the embodiment. As illustrated in FIG. 2, the self-POS terminal 10 includes a settlement terminal 1, a basket holder 2, and a bag holder 3. The settlement terminal 1 includes a deposit and withdrawal unit 4, a reading unit 5, a display operation unit 6, and a control unit 100 (see FIG. 3) for controlling each unit.

The settlement terminal 1 includes a first housing 7 and a second housing 8. The first housing 7 stores the deposit and withdrawal unit 4 inside. The second housing 8 stores the control unit 100 inside.

The reading unit 5 includes a code reader 27 that reads an appearance of a merchandise or a symbol (such as a barcode or a two-dimensional code) attached to the merchandise to specify the merchandise. The reading unit 5 includes a printing unit 24 that prints a receipt relating to a merchandise to be sold. The printing unit 24 dispenses a discharged receipt from a receipt dispense port 51b. The dispensed receipt is supported by a receipt discharging table 51a from the lower side. The reading unit 5 includes the card reader 25 that reads a credit card or an electronic money card relating to a settlement process.

The display operation unit 6 includes the display unit 23, for example, configured with a monitor and the operation unit 21, for example, configured with a touch panel. The display unit 23 displays information or an image. The operation unit 21 is provided on the surface of the display unit 23 and outputs information based on a position touched by a customer to the control unit 100.

The basket holder 2 is a holder for placing a basket for introducing a merchandise. The basket holder 2 is provided on one side of the settlement terminal 1. The customer extracts the merchandise to the basket and holds the merchandise over the reading unit 5. The bag holder 3 is a holder for packing the merchandise after reading the symbol with the code reader 27. The bag holder 3 is provided on the other side (on the opposite side of the basket holder 2) of the settlement terminal 1.

Subsequently, the hardware configuration of the self-POS terminal 10 is described. FIG. 3 is a block diagram illustrating a hardware configuration of the self-POS terminal 10. As illustrated in FIG. 3, the self-POS terminal 10 includes a central processing unit (CPU) 11, a read only memory (ROM) 12, a random access memory (RAM) 13, a memory unit 14, and the like. The CPU 11 is a controlling entity. The ROM 12 stores various programs. The RAM 13 loads a program or various data. The memory unit 14 stores various programs. The CPU 11, the ROM 12, the RAM 13, and the memory unit 14 are connected to each other via the bus 15. The CPU 11, the ROM 12, and the RAM 13 configure the control unit 100. That is, the control unit 100 performs a control process according to the self-POS terminal 10 described below, by an operation of the CPU 11 according to a control program stored in the ROM 12 or the memory unit 14 and loaded in the RAM 13.

The RAM 13 includes the merchandise information unit 131 (storage unit), a merchandise table 132 (table), a settlement information unit 133, and a medium storage unit 135. The merchandise information unit 131 stores a merchandise code and merchandise information (such as the name of the merchandise and a price of the merchandise) of the merchandise subjected to the sales registration process based on the merchandise code acquired from the symbol read by the code reader 27. In the merchandise table 132, determination information for determining whether a plurality of media (settlement unit) for each merchandise code (specific information) are available for the settlement is stored. In the embodiment, the merchandise table 132 stores the determination information for determining whether a merchandise can be settled with the media for each combination of the merchandise code and the plurality of media. The merchandise table 132 is described below in FIG. 4. The settlement information unit 133 acquires and stores the information of the media of which the determination information is “available” from the merchandise table 132 with respect to each merchandise stored in the merchandise information unit 131. The medium storage unit 135 stores the media designated by operating the operation unit 21.

The memory unit 14 is configured with a nonvolatile memory such as a hard disc drive (HDD) or a flash memory that retains the stored information even when the power is turned off. The memory unit 14 includes a control program unit 141 and a merchandise master 142. The control program unit 141 stores a control program for controlling the self-POS terminal 10. The merchandise master 142 stores merchandise information relating to the corresponding merchandise on a per merchandise item basis.

The control unit 100 is connected to an operation unit 21, a display unit 23, the printing unit 24, a card reader 25, the code reader 27, and the deposit and withdrawal unit 4 via a bus 15 and a controller 16. The operation unit 21 includes an end key 211. The end key 211 ends a sales registration operation relating to the merchandise and is operated by the customer when the settlement operation starts. The deposit and withdrawal unit 4 deposits money received from the customer and withdraws a coin to be paid to the customer.

The control unit 100 is connected to a communication unit 26 via the bus 15. The communication unit 26 is electrically connected to the other self-POS terminals 10 or the server 20 installed in the store via the communication line 30. The communication unit 26 transmits and receives information to and from the other self-POS terminals 10 or the server 20.

Subsequently, the merchandise table 132 is described. FIG. 4 is a memory map presenting a merchandise table. The merchandise table 132 stores determination information determining whether the media are available for the settlement with respect to the merchandise of the merchandise code for each combination of the merchandise code and a plurality of media (cash, electronic money, and credit cards of cards a to f) to be used for the settlement. The determination information is the information indicating whether the media are available or the media are not available for the settlement or not for each merchandise, and specifically stores the information of “available” indicating that the media are available for the settlement and the information of “not available” indicating that the media are not available for the settlement for each combination of the merchandise codes and a plurality of media to be used for the settlement. The information of “available” and the information of “not available” are determination information.

The merchandise table 132 includes a merchandise code 1321, cash determination information 1322, electronic money determination information 1323, and credit card determination information 1324. The merchandise code 1321 stores the merchandise code for specifying each merchandise. The cash determination information 1322 stores the information of “available” or the information of “not available” with respect to whether cash is available for the settlement for each merchandise of the merchandise code stored in the merchandise code 1321. The electronic money determination information 1323 stores the information of “available” or the information of “not available” with respect to whether electronic money is available for the settlement for each merchandise of the merchandise code stored in the merchandise code 1321. The credit card determination information 1324 stores the information of “available” or the information of “not available” with respect to whether six kinds of credit cards (the cards a to f) are available for the settlement for each merchandise of the merchandise code stored in the merchandise code 1321.

That is, with reference to the merchandise table 132, it can be known that a merchandise A can be settled with cash and the card a, but cannot be settled with electronic money or the cards b to f. It can be known that merchandises B and N can be settled with any one of cash, electronic money, and the cards a to f, and there is no medium that is not available for the settlement. It can be known that a merchandise C can be settled only with cash and cannot be settled with the other media.

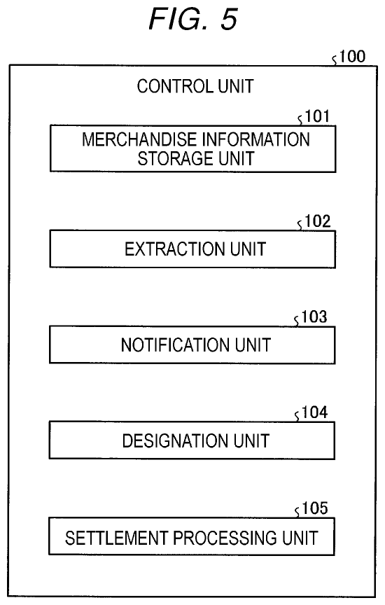

Hereinafter, a function configuration of the self-POS terminal 10 is specifically described. FIG. 5 is a functional block diagram illustrating the functional configuration of the self-POS terminal 10. The control unit 100 functions as a merchandise information storage unit 101, an extraction unit 102, a notification unit 103, a designation unit 104, and a settlement processing unit 105 according to the control program stored in the control program unit 141 of the ROM 12 or the memory unit 14.

The merchandise information storage unit 101 stores the merchandise code for specifying one or a plurality of merchandises subjected to the sales registration process in the merchandise information unit 131 which is the storage unit.

The extraction unit 102 extracts all media that are available for the settlement of the merchandises specified by the merchandise codes stored in the merchandise information unit 131 based on the table in which the determination information for determining whether the media are available for the settlement for each merchandise code, which is the specific information, is stored. Specifically, the extraction unit 102 searches the merchandise table 132 for all merchandise codes stored in the merchandise information unit 131, extracts (information of) all media which is “available” for the settlement for each merchandise code, and stores the information in the settlement information unit 133. That is, the extraction unit 102 extracts all media that are available for the settlement of one or a plurality of merchandises relating to the merchandises of all merchandise codes stored in the merchandise information unit 131. The extraction unit 102 does not extract media which are not available for the settlement of the merchandises specified by the merchandise codes stored in the merchandise information unit 131.

The notification unit 103 notifies (displays) the media extracted by the extraction unit 102 on the display unit 23 to be selectable. That is, the notification unit 103 displays all media that are available in the settlement of one or a plurality of merchandises relating to the merchandises of all merchandise codes stored in the merchandise information unit 131 to be selectable. The notification unit 103 does not display a medium that is not available relating to the merchandises of all merchandise codes stored in the merchandise information unit 131.

The designation unit 104 receives the information of one medium selected from the notified media. Specifically, the designation unit 104 stores the information of the medium associated with the media key operated by the customer among various media keys displayed on the display unit 23 by the notification unit 103, in the medium storage unit 135.

The settlement processing unit 105 performs the settlement process with respect to the merchandise that can be settled with the medium of which the information is received. Specifically, the settlement processing unit 105 uses the medium received by the designation unit 104 and performs the settlement process with respect to the merchandise that can be settled with the medium.

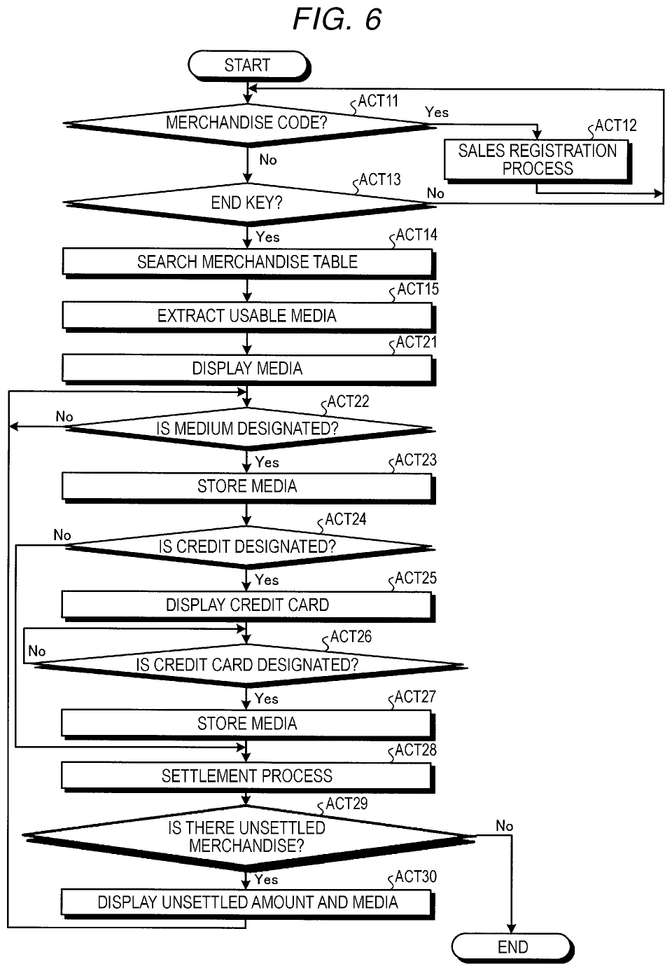

Hereinafter, the control of the self-POS terminal 10 is described. FIG. 6 is a flow chart for describing a flow of a control process of the self-POS terminal 10. As illustrated in FIG. 6, the control unit 100 of the self-POS terminal 10 determines whether a merchandise code relating to the merchandise is acquired based on a symbol read by the code reader 27 (ACT11). When it is determined that the merchandise code is acquired (Yes in ACT11), the control unit 100 performs the sales registration process with respect to the merchandise (ACT12). In ACT12, the merchandise information storage unit 101 stores the merchandise code for specifying one or a plurality of merchandises subjected to the sales registration process in the merchandise information unit 131. In the embodiment, for example, the merchandise codes of three products of the merchandises A, B, and C are stored in the merchandise information unit 131. The control unit 100 returns to ACT11.

When it is determined that the merchandise code is not acquired (No in ACT11), the control unit 100 determines whether the end key 211 is operated (ACT13). When it is determined that the end key 211 is operated (Yes in ACT13), the control unit 100 searches the merchandise table 132 based on all merchandise codes stored in the merchandise information unit 131 (ACT14). The extraction unit 102 extracts (information of) all media which are “available” for the settlement from the merchandise table 132 for each merchandise code and stores the information in the settlement information unit 133 (ACT15).

Subsequently, the notification unit 103 notifies all media extracted by the extraction unit 102 on the display unit 23 to be selectable (ACT21).

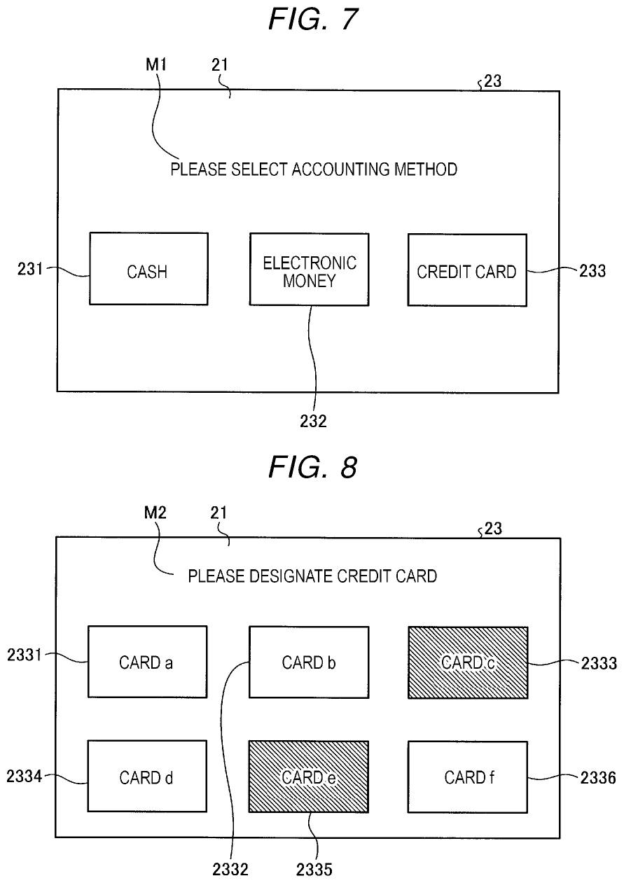

FIG. 7 illustrates a screen displaying the media that are available on the display unit 23 in ACT21. As illustrated in FIG. 7, the display unit 23 displays a cash key 231, an electronic money key 232, and a credit card key 233 that is available for the settlement of any one of the three products of the merchandises A, B, and C. When the merchandises A, B, and C can be settled with cash, the cash key 231 is operated. When the merchandise B is settled with electronic money, the electronic money key 232 is operated. When the merchandises A and B are settled with a credit card, the credit card key 233 is operated. In FIG. 7, the display unit 23 displays guidance M1 for promoting an operation of any one of the cash key 231, the electronic money key 232, and the credit card key 233. The guidance M1 is, for example, “Please select an accounting method”.

The description refers back to FIG. 6. Subsequently, the control unit 100 determines whether any key of the cash key 231, the electronic money key 232, and the credit card key 233 is operated (any medium is designated) (ACT22). The designation unit 104 waits until any key is operated (No in ACT22). When it is determined that any key is operated (Yes in ACT22), the designation unit 104 stores the information indicating the medium associated with the operated media key in the medium storage unit 135 (ACT23). That is, the designation unit 104 receives information of one designated medium.

Subsequently, the control unit 100 determines whether a credit card is designated in ACT22 (that is, whether the information stored in the medium storage unit 135 is the information of a credit card key) (ACT24). When it is determined that the credit card is designated (Yes in ACT24), the control unit 100 displays all credit cards that are available for one or a plurality of kinds of settlement of three products of the merchandises A, B, and C on the display unit (ACT25). FIG. 8 illustrates a screen of credit cards displayed on the display unit 23 in ACT25. FIG. 8 displays six keys: a key 2331 for designating the card a, a key 2332 for designating the card b, a key 2333 for designating the card c, a key 2334 for designating the card d, a key 2335 for designating the card e, and a key 2336 for designating the card f. Among these, the keys 2331, 2332, 2334, and 2336 can be operated (selected). However, since the cards c and e are cards that are not available for the settlement for any one of the three products of the merchandises A, B, and C, the keys 2333 and 2335 are grayed out and cannot be operated (selected). The customer operates any key that can be operated and designates a credit card to be used. In the embodiment, the card b is designated. The display unit 23 displays guidance M2 for promoting designation of a credit card to be used. The guidance M2 is, for example, “Please designate a credit card”.

The description refers back to FIG. 6. The control unit 100 determines any credit card is designated (ACT26). The designation unit 104 waits until any credit card is designated (No in ACT26). When it is determined any credit card is designated (Yes of ACT26), the designation unit 104 receives information of one designated credit card (ACT27). Specifically, the designation unit 104 stores the information of the credit card relating to the operated key among various media keys displayed on the display unit 23 in the medium storage unit 135 (ACT27).

Subsequently, the settlement processing unit 105 performs the settlement process with respect to the merchandise that can be settled with the media stored in the medium storage unit 135 among the merchandises of the merchandise codes stored in the merchandise information unit 131 (ACT28). In the embodiment, since the merchandise B can be settled with the card b, the settlement processing unit 105 performs the settlement process on the merchandise B in the process of ACT28. The control unit 100 deletes the merchandise code and the merchandise information of the merchandise B subjected to the settlement process from the merchandise information unit 131. At this point, the merchandises A and C are unsettled merchandises which are not settled. Therefore, the merchandise code and the merchandise information relating to the merchandises A and C remain stored in the merchandise information unit 131. If it is determined that a credit card is not designated in ACT24 (No in ACT24), the control unit 100 performs the determination of ACT29 by using operated media without performing processes of ACT25 to ACT27.

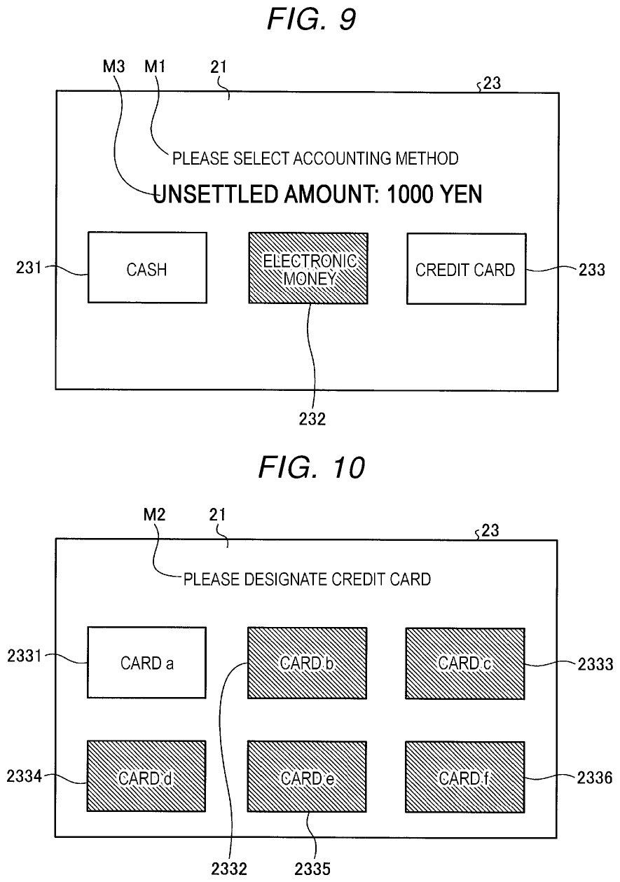

Subsequently, the control unit 100 determines whether there is an unsettled merchandise (ACT29). When the merchandise code and the merchandise information are stored in the merchandise information unit 131, the control unit 100 determines that there is an unsettled merchandise. When it is determined that there is an unsettled merchandise (Yes in ACT29), the notification unit 103 calculates the total amount of the unsettled merchandises and displays the amount on the display unit 23 based on the merchandise information stored in the merchandise information unit 131 (ACT30). FIG. 9 illustrates the display unit 23 that displays the guidance and the total amount of the unsettled merchandises. The display unit 23 displays the guidance M1, guidance M3 that indicates that there are unsettled merchandises together with the total amount of the unsettled merchandises, the cash key 231, the electronic money key 232, and the credit card key 233. In the example of FIG. 9, since the unsettled merchandises A and C cannot be settled with electronic money, the electronic money key 232 is grayed out and cannot be operated. The customer recognizes that there are unsettled merchandises based on the displayed guidance M3. In the example of FIG. 9, the guidance M3 indicates that the total amount of the merchandises A and C is 1,000 yen. The customer operates any key of the cash key 231 and the credit card key 233 with respect to the unsettled merchandises and designates a medium to be used for the settlement. The control unit 100 returns to ACT22 and waits for designation of a new medium.

In the example of FIG. 9, since the merchandises A and C are still unsettled, the control unit 100 waits for designation of a medium to be newly used for the merchandises A and C. Since the merchandise A can be settled with cash or the card a, when the cash key 231 or the credit card key 233 is operated, the settlement process on the merchandise A can be performed. Since the merchandise C can be settled with cash, when the cash key 231 is operated, the settlement process can be performed on the merchandise A. Meanwhile, when it is determined that there is no unsettled merchandise (No in ACT29), all merchandises are settled, and thus the control unit 100 ends the process.

FIG. 10 indicates an example of a display in ACT25 when the credit card key 233 is operated in ACT24 when the merchandises A and C are unsettled. Since the card a is available for the merchandise A, and a credit card is not available for the merchandise C, the key 2331 that is available for the settlement of the merchandise A is operably displayed and other keys are grayed out and cannot be operated in ACT25. When the key 2331 is operated, the settlement processing unit 105 performs the settlement process of the merchandise A in ACT28. Thereafter, if the process returns to ACT22, and cash is designated for the merchandise C, the settlement processing unit 105 performs the settlement process of the merchandise C.

The self-POS terminal 10 according to the embodiment includes the merchandise information storage unit 101 that stores specific information for specifying one or a plurality of merchandises subjected to the sales registration process in the merchandise information unit 131; the extraction unit 102 that extracts all media that are available for the settlement of the merchandise specified with the merchandise code stored in the merchandise information unit 131 based on a table in which determination information for determining whether the media are available for the settlement for each merchandise code is stored; the notification unit 103 that displays the extracted media to be selectable; the designation unit 104 that receives information of one medium selected from the notified media; and the settlement processing unit 105 that performs the settlement process with respect to the merchandise that can be settled with the media of which the information is received. The self-POS terminal 10 displays the available media extracted by the extraction unit 102, uses the designated media, and performs the settlement process on the merchandise that can be settled. Therefore, a medium that is available for the settlement of a merchandise to be purchased can be notified in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the description is made by using the self-POS terminal 10 as an example of the settlement terminal. However, the exemplary embodiment is not limited thereto, and the settlement terminal may be a settlement terminal in a general POS terminal or a semi-self POS terminal.

In the embodiment, a configuration in which the self-POS terminal 10 includes the merchandise table 132 is described. However, the exemplary embodiment is not limited thereto, and the merchandise table 132 may be configured to be included in a device (for example, the server 20) other than the self-POS terminal 10.

In the embodiment, determination information for determining whether a medium is available for settlement for a merchandise for each combination of a merchandise code and a plurality of media is stored in the merchandise table 132. However, the exemplary embodiment is not limited thereto, and for example, the information of an available medium may be stored in an associated manner on a per merchandise item basis.

The program executed by the self-POS terminal 10 of the embodiment is stored and provided in a file in an installable format or an executable format on a computer-readable recording medium such as a CD-ROM, a flexible disk (FD), a CD-R, and a digital versatile disk (DVD).

The program executed by the self-POS terminal 10 according to the embodiment may be configured to be stored on a computer connected to a network such as the Internet and provided by being downloaded via the network. The program executed by the self-POS terminal 10 of the embodiment may be configured to be provided or distributed via a network such as the Internet.

The program to be executed by the self-POS terminal 10 of the embodiment may be configured to be provided by being incorporated in a ROM or the like in advance.

What is claimed is:

1. A settlement device, comprising:
merchandise information storage component for storing specific information for specifying one or a plurality of merchandises subjected to a sales registration process in a storage component;
extraction component for extracting all settlement means available for settlement of the merchandise specified by the specific information stored in the storage component based on a table in which determination information for determining whether the plurality of kinds of settlement means are respectively available for settlement for each kind of the specific information is stored;
notification component for notifying the extracted settlement means to be selectable;
designation component for receiving information of one kind of the settlement means selected from the notified settlement means; and
settlement processing component for performing a settlement process on the merchandise that can be settled with the settlement means of which the information is received.

2. The device according to claim 1, wherein
the notification component notifies all the settlement means that is available for settlement of an unsettled merchandise on which the settlement processing component does not perform the settlement process to be selectable.

3. The device according to claim 2, wherein
the notification component notifies unsettled price information relating to the unsettled merchandise.

4. The device according to claim 3, wherein
the notification component further notifies information of the settlement means which is available for settlement of the unsettled merchandise as the information relating to the unsettled merchandise.

5. The device according to claim 1, further comprising:
a table.

6. The device according to claim 1, further comprising:
a display,
wherein the notification component notifies the extracted settlement means to be selectable via a display.

7. A method performed by a computer as a settlement device, the method comprising:
storing specific information for specifying one or a plurality of merchandises subjected to a sales registration process in a storage component;
extracting all settlement means that is available for settlement of the merchandise specified with the specific information stored in the storage component based on a table in which determination information for determining whether the plurality of kinds of settlement means are respectively available for settlement for each kind of the specific information is stored;
notifying the extracted settlement means to be selectable;
receiving information of one kind of the settlement means selected from the notified settlement means; and
performing a settlement process on the merchandise that can be settled with the settlement means of which the information is received.

8. The method according to claim 7, further comprising:
notifying all the settlement means that is available for settlement of an unsettled merchandise on which the settlement processing component does not perform the settlement process to be selectable.

9. The method according to claim 8, further comprising:
notifying unsettled price information relating to the unsettled merchandise.

10. The method according to claim 9, further comprising:
notifying information of the settlement means which is available for settlement of the unsettled merchandise as the information relating to the unsettled merchandise.

11. The method according to claim 7, further comprising:
displaying the extracted settlement means to be selectable.

12. A POS settlement system, comprising:
a plurality of POS settlement devices;
merchandise information storage component for storing specific information for specifying one or a plurality of merchandises subjected to a sales registration process in a storage component;
extraction component for extracting all settlement means available for settlement of the merchandise specified by the specific information stored in the storage component based on a table in which determination information for determining whether the plurality of kinds of settlement means are respectively available for settlement for each kind of the specific information is stored;
notification component for notifying the extracted settlement means to be selectable;
designation component for receiving information of one kind of the settlement means selected from the notified settlement means; and
settlement processing component for performing a settlement process on the merchandise that can be settled with the settlement means of which the information is received.

13. The POS settlement system according to claim 12, wherein
the notification component notifies all the settlement means that is available for settlement of an unsettled merchandise on which the settlement processing component does not perform the settlement process to be selectable.

14. The POS settlement system according to claim 13, wherein
the notification component notifies unsettled price information relating to the unsettled merchandise.

15. The POS settlement system according to claim 14, wherein
the notification component further notifies information of the settlement means which is available for settlement of the unsettled merchandise as the information relating to the unsettled merchandise.

16. The POS settlement system according to claim 12, further comprising:
a table.

17. The POS settlement system according to claim 12, further comprising:
a display,
wherein the notification component notifies the extracted settlement means to be selectable via a display.

18. The POS settlement system according to claim 12, wherein
the POS settlement devices are self POS settlement devices.

19. The POS settlement system according to claim 12, wherein
the POS settlement devices are semi-self POS settlement devices.
